(19) United States
(12) Patent Application Publication
(10) Pub. No.: US 2010/0295499 A1
(43) Pub. Date: Nov. 25, 2010

(54) Stepping motor control circuit and analog electronic timepiece

(76) Inventors: Keishi Honmura, Chiba-shi (JP); Akira Takakura, Chiba-shi (JP); Saburo Manaka, Chiba-shi (JP); Kenji Ogasawara, Chiba-shi (JP); Kazumi Sakumoto, Chiba-shi (JP); Hiroshi Shimizu, Chiba-shi (JP); Kazuo Kato, Chiba-shi (JP); Takanori Hasegawa, Chiba-shi (JP); Kosuke Yamamoto, Chiba-shi (JP)

Correspondence Address: BRUCE L. ADAMS, ESQ, SUITE 1231, 17 BATTERY PLACE, NEW YORK, NY, 10004, US

(21) Appl. No.: 12/800,707

(22) Filed: May 20, 2010

(30) Foreign Application Priority Data
May 21, 2009 (JP) 2009-123471
Mar. 23, 2010 (JP) 2010-065992

(51) Int. Cl. H02P 8/38; G04B 19/04

(52) U.S. Cl. 318/696; 368/80

(57) ABSTRACT

When a reset operation or the driving by a correction drive pulse P2 is performed, a stepping motor is driven by a plurality of main drive pulses P0 for initial setting stored in a storage circuit and the stepping motor is rotary driven by a correction drive pulse P2 following the respective main drive pulses P0, so that the main drive pulses P0 with energy as large as or larger than energy by which it is determined to maintain the pulse rank are used as main drive pulses P1 during normal correction drive. It thus becomes possible to perform driving by a main drive pulse suitable for the stepping motor in consideration of a characteristic variation of the stepping motor.

### BACKGROUND OF THE INVENTION

1. Field of the Invention

The present invention relates to a stepping motor control circuit and an analog electronic timepiece using the stepping motor control circuit.

2. Background Art

A bipolar PM (Permanent Magnet) stepping motor is used in an electronic device, such as an analog electronic timepiece. The bipolar PM stepping motor includes a stator having a rotor accommodation hole and a positioning portion that determines a rotor stop position, a rotor provided in the rotor accommodation hole, and a coil, and it is configured to rotate the rotor and to stop the rotor at a position corresponding to the positioning portion by supplying an alternating signal to the coil for the stator to generate a magnetic flux.

As a low-consumption drive method of the bipolar PM stepping motor, a correction drive method of a stepping motor provided with a main drive pulse P1 with small energy responsible for driving during normal times and a correction drive pulse P2 with large energy responsible for driving at a time of load fluctuation is in practical use. It is configured in such a manner that the main drive pulse P1 decreases and increases energy depending on whether the rotor is rotating or not to shift a rank of drive energy to drive the stepping motor with the smallest possible energy as is described, for example, in JP-B-61-15385.

This correction drive method is configured as follows. That is, (1) a main drive pulse P1 is outputted to one of the poles of the coil, O1, to detect an induced voltage generated in the coil by rotor oscillations that occur immediately after the output. (2) In a case where the induced voltage exceeds an arbitrarily-set reference threshold voltage, it is determined that the rotor is rotating and the main drive pulse P1 maintaining the energy is outputted to the other pole of the drive coil, O2. This operation is repeated a certain number of times as long as the rotor is rotating. When the number of repetition times reaches a certain number of times (PCD), the main drive pulse P1 with smaller energy is further outputted to the other pole O1 to repeat the process again. (3) In a case where the induced voltage does not exceed the reference threshold voltage, it is determined that the rotor is not rotating. A correction drive pulse P2 with large energy is thus immediately outputted to the same pole to forcedly rotate the rotor. During the next driving, (1) through (3) are repeated by outputting, to the other pole, the main drive pulse P1 with energy one rank larger than that of the main drive pulse P1 with which the rotor fails to rotate.

Also, according to the invention described in WO 2005/119377, means for determining a detection time of an induced signal by a comparison with a reference time when detecting rotations of the stepping motor is provided in addition to a detection of an induced signal level. After the stepping motor is rotary driven by a main drive pulse P11, a correction drive pulse P2 is outputted when the induced signal drops below a predetermined reference threshold voltage Vcomp. A following main drive pulse P1 is changed (pulse up) to a main drive pulse P12 with energy larger than that of the main drive pulse P11 and then the stepping motor is driven. When a detection time with the rotations by the main drive pulse P12 is earlier than the reference time, the main drive pulse P12 is changed (pulse down) to the main drive pulse P11. Power consumption is thus reduced by rotating the stepping motor by the main drive pulses P1 corresponding to the load during the driving.

However, irregularities in movement and fluctuations of the load and energy are all addressed by a plurality of main drive pulses P1 set initially in an integrated circuit (IC) that contains a stepping motor control circuit. Accordingly, the stepping motor is driven by a main drive pulse with too small drive energy or by a main drive pulse with too large energy for individual movements, which may give rise to a malfunction or useless driving.

### SUMMARY OF THE INVENTION

It is an aspect of the present invention to enable driving by a main drive pulse suitable for a stepping motor in consideration of a characteristic variation of the stepping motor.

A stepping motor control circuit according to the aspect of the invention includes a rotation detection portion that detects an induced signal generated by a rotation of a rotor in a stepping motor and detects a rotation condition of the stepping motor depending on whether the induced signal exceeds a predetermined reference threshold voltage within a predetermined detection interval, and a control portion that drives and controls the stepping motor by one of any one of a plurality of main drive pulses in pulse ranks that differ from one another and a correction drive pulse with energy larger than energy of the respective main drive pulses according to a detection result of the rotation detection portion. The control portion preliminarily selects main drive pulses of a second group made up of a plurality of main drive pulses capable of rotary driving the stepping motor collectively from main drive pulses of a first group made up of a plurality of preliminarily provided main drive pulses and drives and controls the stepping motor by one of any one of the main drive pulses of the second group and the correction drive pulse according to the detection result of the rotation detection portion.

It may be configured in such a manner that the control portion selects the main drive pulses of the second group collectively from the main drive pulses of the first group at predetermined timing while performing a driving operation of the stepping motor.

It may be configured in such a manner that the control portion selects the main drive pulses of the second group collectively from the main drive pulses of the first group when one of a reset operation and driving by the correction drive pulse is performed.

It may be configured in such a manner that the control portion selects the main drive pulses of the second group by performing driving by a set of a main drive pulse of the first group and the correction drive pulse following this main drive pulse for the respective main drive pulses of the first group after one of the reset operation and the driving by the correction drive pulse is performed.

It may be configured in such a manner that the detection interval is divided to a plurality of sections immediately after driving by a main drive pulse and the control portion selects the main drive pulses of the second group from the main drive pulses of the first group according to a pattern of the induced signal in the plurality of sections.

It may be configured in such a manner that the control portion selects a main drive pulse with energy as large as or larger than energy by which it is determined to maintain a pulse rank according to the pattern of the induced signal in the plurality of sections as the main drive pulses of the second group.

It may be configured in such a manner that the detection interval is divided to a first section immediately after driving by a main drive pulse, a second section later than the first section, and a third section later than the second section, and the first section is a section in which to determine a rotation of the rotor in a positive direction in a second quadrant about the rotor and the second section and the third section are sections in which to determine a rotation of the rotor in an inverse direction in a third quadrant, and that the control portion selects the main drive pulses of the second group from the main drive pulses of the first group according to the pattern in the first through third sections.

It may be configured in such a manner that the control portion selects a main drive pulse with which the induced signal exceeding the reference threshold voltage is detected in the second section of the pattern as the main drive pulses of the second group.

It may be configured in such a manner that the stepping motor control circuit further includes a storage portion that stores information on the main drive pulses of the first group and the main drive pulses of the second group, and that the control portion selects the main drive pulses of the second group using the information on the main drive pulses of the first group stored in the storage portion, stores the information on the main drive pulses of the second group in the storage portion, and performs driving using the main drive pulses of the second group stored in the storage portion after the main drive pulses of the second group are selected.

An analog electronic timepiece according to another aspect of the invention includes a stepping motor that rotary drives time hands, and a stepping motor control circuit that controls the stepping motor. The stepping motor control circuit having any one of the configurations described above is used as the stepping motor control circuit.

According to the stepping motor control circuit of the invention, it becomes possible to drive the stepping motor by a main drive pulse suitable for the stepping motor in consideration of a characteristic variation of the stepping motor.

Also, according to the analog electronic timepiece of the invention, a precise hand movement operation can be achieved because it becomes possible to drive the stepping motor by a main drive pulse suitable for the stepping motor in consideration of a characteristic variation of the stepping motor.

### BRIEF DESCRIPTION OF THE DRAWINGS

FIG. 1 is a block diagram of a stepping motor control circuit and an analog electronic timepiece according to one embodiment of the invention;

FIG. 2 is a view showing the configuration of a stepping motor used in the analog electronic timepiece according to one embodiment of the invention;

FIG. 3 is a timing chart used to describe operations of the stepping motor control circuit and the analog electronic timepiece according to one embodiment of the invention;

FIG. 4 is a flowchart depicting operations of the stepping motor control circuit and the analog electronic timepiece according to one embodiment of the invention;

FIG. 5 is a flowchart depicting operations of the stepping motor control circuit and the analog electronic timepiece according to one embodiment of the invention;

FIG. 6 is a timing chart used to describe operations of the stepping motor control circuit and the analog electronic timepiece according to another embodiment of the invention; and

FIG. 7 is a flowchart depicting operations of the stepping motor control circuit and the analog electronic timepiece according to still another embodiment of the invention.

### DESCRIPTION OF THE PREFERRED EMBODIMENTS

Hereinafter, a stepping motor control circuit and an analog electronic timepiece using the same according to one embodiment of the invention will be described. Like components are labeled with like reference numerals in the respective drawings.

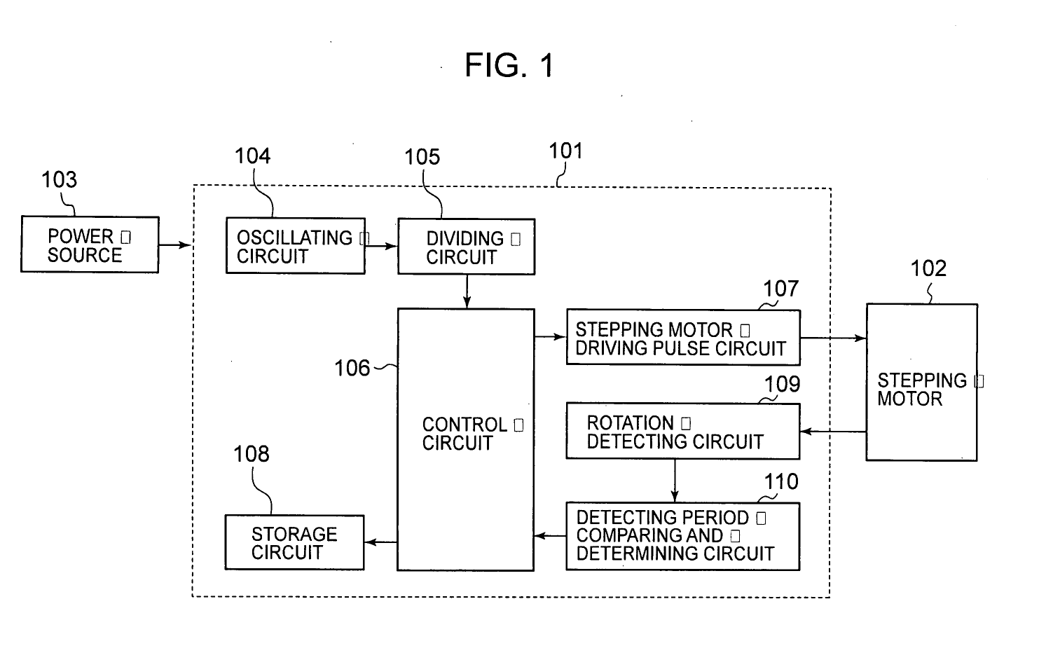

FIG. 1 is a block diagram of an analog electronic timepiece using a stepping motor control circuit according to one embodiment of the invention and it shows a case where the analog electronic timepiece is an analog electronic watch.

Referring to FIG. 1, the analog electronic timepiece includes a stepping motor control circuit 101, a stepping motor 102 that is rotated under the control of the stepping motor control circuit 101 and rotary drives the time hands and a calendar mechanism (not shown), and a power supply 103, such as a battery, that supplies drive power to circuit elements, such as the stepping motor control circuit 101 and the stepping motor 102.

The stepping motor control circuit 101 includes an oscillation circuit 104 that generates a signal at a predetermined frequency, a frequency dividing circuit 105 that frequency-divides a signal generated in the oscillation circuit 104 to generate a timepiece signal that serves as the timekeeping reference, a control circuit 106 that controls respective electronic circuit elements forming the electronic timepiece and controls a change of a drive pulse, a stepping motor drive pulse circuit 107 that selects a drive pulse for motor rotary driving according to a control signal from the control circuit 106 and outputs the selected drive pulse to the stepping motor 102, a rotation detection circuit 109 that detects an induced signal indicating a rotation condition from the stepping motor 102 in a predetermined detection period, a detection time comparison and determination circuit 110 that compares a time when an induced signal exceeding a predetermined reference threshold voltage is detected by the rotation detection circuit 109 with sections forming the detection period to detect in which section the induced signal is detected, and a storage circuit 108 that stores information on main drive pulses P1 and a correction drive pulse P2.

The rotation detection circuit 109 is based on the same principle as that of the rotation detection circuit described in JP-B-61-15385. It detects whether an induced signal VRs generated by free oscillations immediately after the driving of the stepping motor 102 exceeds a predetermined reference threshold voltage Vcomp in a predetermined detection period and each time it detects an induced signal VRs exceeding the reference threshold voltage Vcomp, it notifies the detection time comparison and determination circuit 110 of the detection.

The storage circuit 108 not only stores information on main drive pulses in a plurality of types of pulse ranks preliminarily provided to the stepping motor control circuit 101 and information on a correction drive pulse, but also information on a plurality of types of main drive pulses selected by a selection process described below.

It should be noted that the oscillation circuit 104 and the frequency dividing circuit 105 together form a signal generation portion. The storage circuit 108 forms a storage portion. The rotation detection circuit 109 and the detection time comparison and determination circuit 110 together form a rotation detection portion. Also, the oscillation circuit 104, the frequency dividing circuit 105, the control circuit 106, the stepping motor drive pulse circuit 107, and the storage circuit 108 together form a control portion.

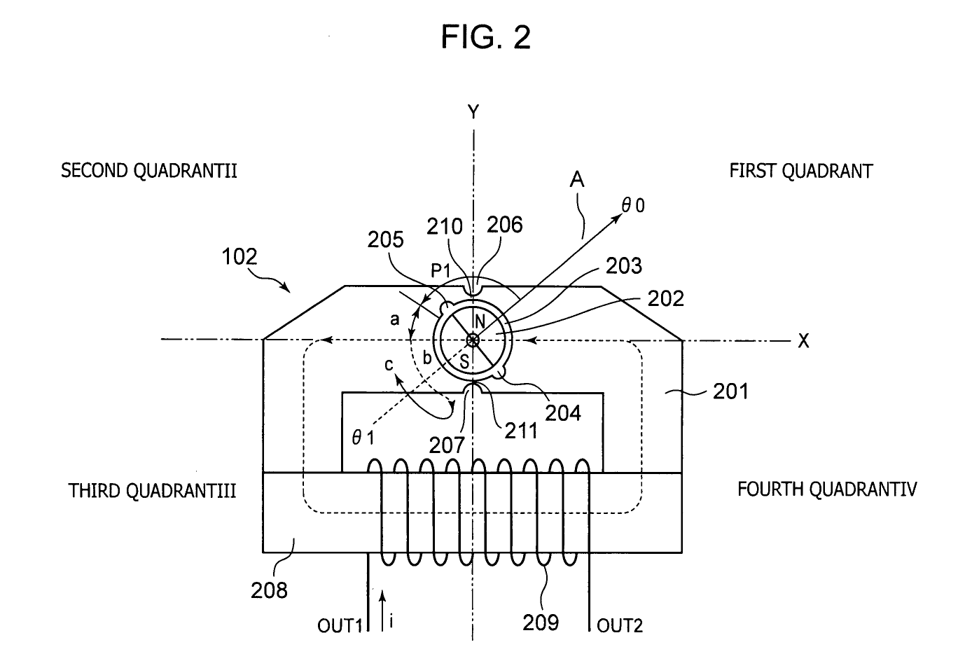

FIG. 2 is a view showing the configuration of the stepping motor 102 used in one embodiment of the invention and it shows a case where the stepping motor 102 is a bipolar PM stepping motor typically used in an analog electronic timepiece.

Referring to FIG. 2, the stepping motor 102 includes a stator 201 having a rotor accommodation through-hole 203, a rotor 202 provided in the rotor accommodation through-hole 203 in a rotatable manner, a magnetic core 208 joined to the stator 201, and a coil 209 wound around the magnetic core 208. In a case where the stepping motor 102 is used in an analog electronic timepiece, the stator 201 and the magnetic core 208 are fixed to a bottom board (not shown) with screws (not shown) and joined to each other. The coil 209 has a first terminal OUT1 and a second terminal OUT2.

The rotor 202 is magnetized to two poles (South pole and North pole). A plurality (two, herein) of notch portions (outer notches) 206 and 207 are provided to the outer end portion of the stator 201 made of a magnetic material at positions opposing each other with the rotor accommodation through-hole 203 in between. Saturable portions 210 and 211 are provided between the respective outer notches 206 and 207 and the rotor accommodation through-hole 203.

The saturable portions 210 and 211 are configured in such a manner that they are not magnetically saturated with a magnetic flux of the rotor 202 but magnetically saturated when the coil 209 is excited so that the magnetic resistance becomes larger. The rotor accommodation through-hole 203 is made in a circular hole shape formed integrally with a plurality (two, herein) of crescentic notch portions (inner notches) 204 and 205 in opposing portions of the through-hole having a circular outline.

The notch portions 204 and 205 form a positioning portion used to determine a stop position of the rotor 202. In a state where the coil 209 is not excited, the rotor 202 stably stops at a position corresponding to the positioning portion as is shown in FIG. 2, in other words, at a position (position at an angle θ0) at which the axis of magnetic poles, A, of the rotor 202 intersects at right angles with a line linking the notch portions 204 and 205. The X-Y coordinate space about the rotation shaft of the rotor 202 is divided to four quadrants (first quadrant through fourth quadrant).

When a current i is flown in the direction indicated by an arrow of FIG. 2 by supplying a rectangular-wave drive pulse of a first polarity (for example, the first terminal OUT1 is the positive pole and the second terminal OUT2 is the negative pole) from the stepping motor drive pulse circuit 107 between the terminals OUT1 and OUT2 of the coil 209, a magnetic flux is generated in the stator 201 in the direction indicated by a broken arrow. Accordingly, the saturable portions 210 and 211 are saturated and the magnetic resistance becomes larger. Thereafter, the rotor 202 rotates by 180 degrees in the direction indicated by an arrow of FIG. 2 by an interaction of the magnetic pole generated in the stator 201 and the magnetic pole of the rotor 202 and the axis of magnetic poles, A, stably stops at a position at an angle θ1. It should be noted that a rotation direction to perform a normal operation (herein, a hand movement operation because a description in this embodiment is given to the analog electronic timepiece) by rotary driving the stepping motor 102 is defined as a positive direction (counterclockwise direction in FIG. 2) and a direction inverse to this direction (clockwise direction) is defined as an inverse direction.

Subsequently, when the current i is flown inversely to the direction indicated by the arrow of FIG. 2 by supplying a rectangular-wave drive pulse of a second polarity (the first terminal OUT1 is the negative pole and the second terminal OUT2 is the positive pole so that the polarity is inversed to the polarity of the driving described above) different from the first polarity from the stepping motor drive pulse circuit 107 between the terminals OUT1 and OUT2 of the coil 209, a magnetic flux is generated in the stator 201 in a direction inverse to the direction indicated by the broken line. Accordingly, the saturable portions 210 and 211 are saturated first and then the rotor 202 rotates by 180 degrees in the same direction described above (positive direction) by an interaction of the magnetic pole generated in the stator 201 and the magnetic pole of the rotor 202 and the axis of magnetic poles, A, stably stops at the position at the angle θ0.

It is configured in such a manner that by supplying thereafter a signal having different polarities (alternating signal) to the coil 209 in this manner, the operation described above is performed repetitively, so that the rotor 202 is rotated continuously by 180 degrees at a time in the direction indicated by the arrow. Although it will be described below, a plurality of main drive pulses P11 through P1max with drive energy that differs from one to another and a correction drive pulse P2 are used in this embodiment. Regarding the magnitude (pulse rank) of the drive energy of the main drive pulses P1, the drive energy of P11 is the minimum and that of P1max is the maximum.

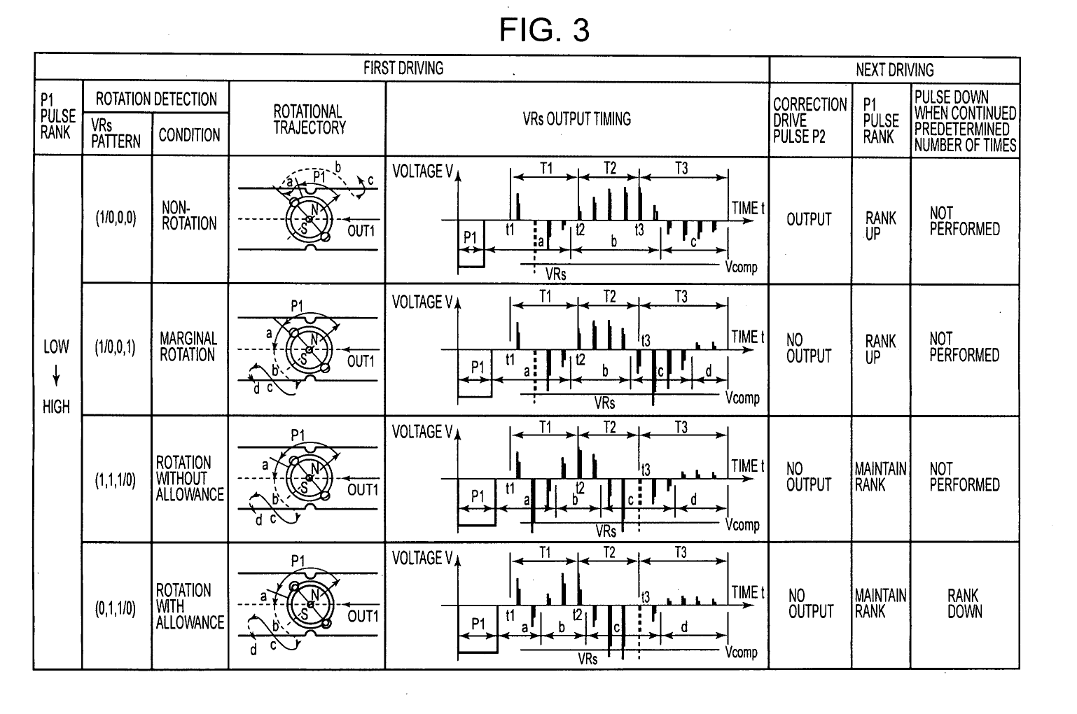

FIG. 3 is a timing chart in a case where the stepping motor 102 is driven by the main drive pulses P1 in this embodiment. It also shows a VRs pattern indicating the rotation condition, the rotation position of the rotor 202, and a pulse control operation as to whether the pulse rank of the main drive pulse P1 is to be changed, the driving by the correction drive pulse P2 is to be performed, and pulse down is to be performed when the driving is continued a predetermined number of times.

Referring to FIG. 3, P1 indicates the main drive pulse 21 and also indicates a section in which the rotor 202 is rotary driven by the main drive pulse P1. Lower-case letters a through d represent regions indicating the rotation position of the rotor 202 by free oscillations after the driving by the main drive pulse P1 is stopped.

A predetermined time immediately after the driving by the main drive pulse P1 is referred to as a first section T1, a predetermined time following the first section T1 is referred to as a second section T2, and a predetermined time following the second section T2 is referred to as a third section T3. In this manner, the entire detection interval T that starts immediately after the driving by the main pulse P1 is divided to a plurality of sections (herein, three sections T1 through T3).

Because a time from the end of the driving by the main drive pulse P1 to the start of the detection period T is set to a certain time, it is configured in such a manner that in the case of main drive pulses other than the main drive pulse P1max in the highest pulse rank, a blank time is generated between the main drive pulse P1 and the first section T1, whereas in the case of the main drive pulse P1max in the highest pulse rank, the main drive pulse P1 and the first section T1 become continuous.

In a case where the X-Y coordinate space in which the main magnetic pole A of the rotor 202 is positioned due to its rotation is divided to the first through forth quadrants about the rotor 202, the first section T1 through the third section T3 can be described as follows. That is, the first section T1 is a section in which to determine rotations of the rotor 202 in the positive direction (region a) in the second quadrant, and the second section T2 and the third section T3 are sections in which to determine rotations of the rotor 202 in the inverse direction (region c) in the third quadrant.

The reference threshold voltage Vcomp is a reference threshold voltage in reference to which the voltage level of the induced signal VRs generated in the stepping motor 102 is determined in order to determine the rotation condition of the stepping motor 102. The reference threshold voltage Vcomp is set in such a manner that the induced signal VRs exceeds the reference threshold voltage Vcomp in a case where the rotor 202 performs a constant fast operation like in a case where the stepping motor 102 rotates, whereas the induced signal VRs does not exceed the reference threshold voltage Vcomp in a case where the rotor 202 does not perform a constant fast operation like in a case where the stepping motor 102 does not rotate.

Regarding the induced signal VRs generated by rotary free oscillations of the stepping motor 102, for example, in the case of a normal load (a load driven during normal times and, herein, a load when the time hands (hour hand, minute hand, and second hand) to display a time) are driven, the rotation angle of the rotor 202 after the main drive pulse P1 is cut off overpasses the second quadrant. Hence, the induced signal VRs exceeding the reference threshold voltage Vcomp for rotation detection does not appear in the first section T1 and appears in and after the second section T2. In a case where a rotation allowance is large, the induced signal VRs appears in the second section T2 because the rotor 202 rotates fast and in a case where a rotation allowance is not large, it appears in the third section T3 because the rotor 202 rotates slow.

In a case where rotations of the rotor 202 no longer have an allowance, the rotor rotation oscillations after the main drive pulse P1 is cut off appear in a region (region a) of the second quadrant and the induced signal VRs appears in the first section T1. This indicates a state where a rotation allowance has been decreasing.

In light of the characteristics as above, it is configured in such a manner that the drive control is performed by a suitable drive pulse by precisely determining an allowance in drive energy.

For example, in a condition of rotation with an allowance of FIG. 3, the induced signal VRs generated in the area a occurs in the first section T1, and the induced signal VRs generated in the region c occurs in the second section T2 and the third section T3. It should be noted that the induced signal VRs generated in the region b occurs over the first section T1 and the second section T2. This induced signal VRs, however, is not detected because it occurs in the polarity opposite to that of the reference threshold voltage Vcomp.

The pattern of the induced signal VRs (VRs pattern) is indicated by a combination of determination values as to whether the induced signal VRs exceeds the reference threshold voltage Vcomp in the respective sections T1 through T3, and it is indicted as (the determination value in the first section T1, the determination value in the second section T2, and the determination value in the third section T3). A case where the induced signal VRs exceeds the reference threshold voltage Vcomp is indicated by a determination value, “1”. A case where the induced signal VRs does not exceed the reference threshold voltage Vcomp is indicated by a determination value, “0”. A case where the determination value can take either “1” or “0” is indicated by “1/0”.

Referring to FIG. 3, for example, in a case where the VRs pattern as the result of driving by the main drive pulse P1 is (0, 1, 1/0), the control circuit 106 determines that the rotation condition is a rotation with an allowance in drive energy (rotation with allowance) and neither performs driving by the correction drive pulse P2 nor changes the rank of the main drive pulse P1 but maintains the rank. It should be noted, however, that in a case where the pattern, (0, 1, 1/0), occurs successively a predetermined number of times (PCD), the control portion 106 determines that there is an allowance in the drive energy and downgrades the main drive pulse P1 by one rank (pulse down).

In a case where the VRs pattern is (1, 1, 1/0), the control circuit 106 determines that the rotation condition is a rotation without an allowance in drive energy (rotations without allowance) and performs pulse control not to change the main drive pulse P1 and thereby to maintain the rank without performing the driving by the correction drive pulse P2.

Ina case where the VRs pattern is (1/0, 0, 1), the control portion 106 determines that the rotation condition is a rotation with absolutely no allowance in drive energy (marginal rotations) and upgrades the main pulse P1 by one rank (pulse up) sufficiently ahead of time without performing the driving by the correction drive pulse P2 to avoid the stepping motor 102 from not rotating during the next driving.

In a case where the VRs pattern is (1/0, 0, 0), the control circuit 106 determines that the stepping motor 102 is not rotating (non-rotation) and upgrades the main drive pulse P1 by one rank after the driving by the correction drive pulse P2 is performed.

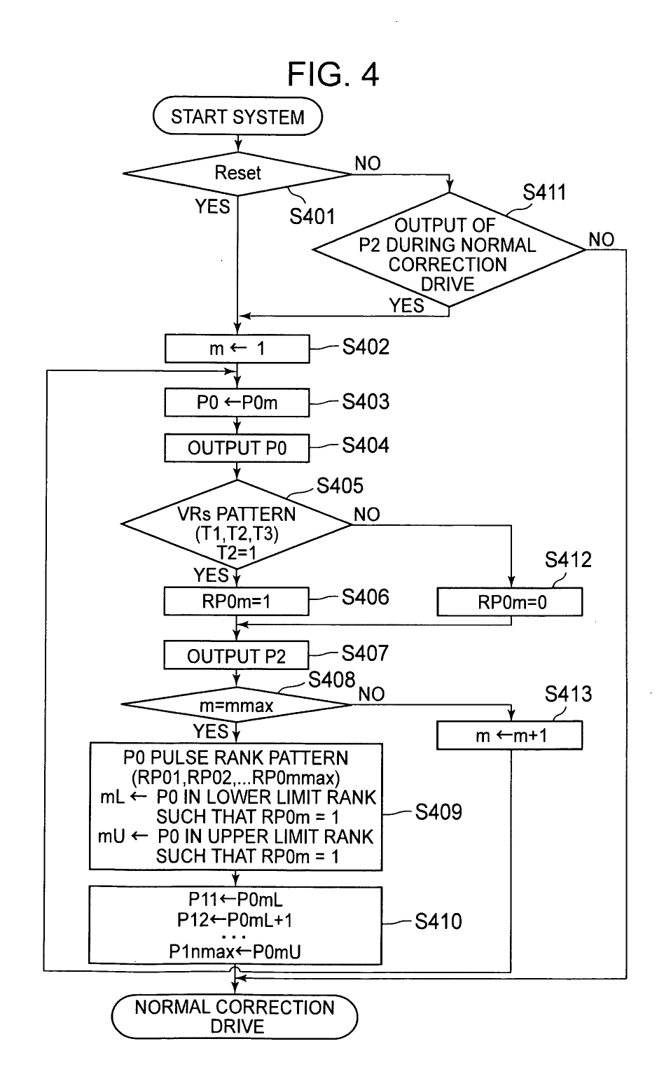

FIG. 4 is a flowchart depicting operations of the stepping motor control circuit and the analog electronic timepiece according to one embodiment of the invention. It is a flowchart depicting a process (drive pulse selection process) to select a plurality of main drive pulses used to drive the electronic timepiece from a plurality of preliminarily provided main drive pulses.

Meanings of the respective symbols in FIG. 4 are as follows. That is, P0 indicates main drive pulses for initial setting (main drive pulses of a first group) preliminarily provided to the stepping motor control circuit 101 and include a plurality of types in pulse ranks for the respective main drive pulses from P01 in the minimum pulse rank to P0nmax in the maximum pulse rank. A lower-case letter m indicates a pulse rank of the main drive pulses P0 for initial setting preliminarily provided to the stepping motor control circuit 101 and it includes from the minimum rank 1 to the maximum rank mmax. P1 indicates main drive pulses for normal correction drive (main drive pulses of a second group) used during a normal drive operation (during normal correction drive) and includes a plurality of types from P11 in the minimum pulse rank to P1max in the maximum pulse rank.

The main drive pulses P1 for normal correction drive are main drive pulses selected from the main drive pulses P0 for initial setting by a drive pulse selection process described below. A lower-case letter n indicates a pulse rank of the main drive pulses P1 during normal correction drive and it includes a plurality of types from the minimum rank 1 to the maximum rank nmax. P2 indicates a correction drive pulse during normal drive and has drive larger energy than the main drive pulse P0max for initial setting with the maximum energy preliminarily provided to the stepping motor control circuit 101. Regarding the pulse rank pattern, (RP01, RP02, . . . , and RP0 mmax), a case where the second section T2 in the VRs pattern is indicated by “1” during the driving by the main drive pulse P0m is indicated as RP0m=1. Information on the main drive pulses P0 for initial setting and the correction drive pulse P2 is pre-stored in the storage circuit 108. Information on the main drive pulses P1 for normal correction drive is selected from the main drive pulses P0 for initial setting in the drive pulse selection process and stored in the storage circuit 108. The information is readout from the storage circuit 108 during the normal correction drive and used during the driving by the main drive pulses.

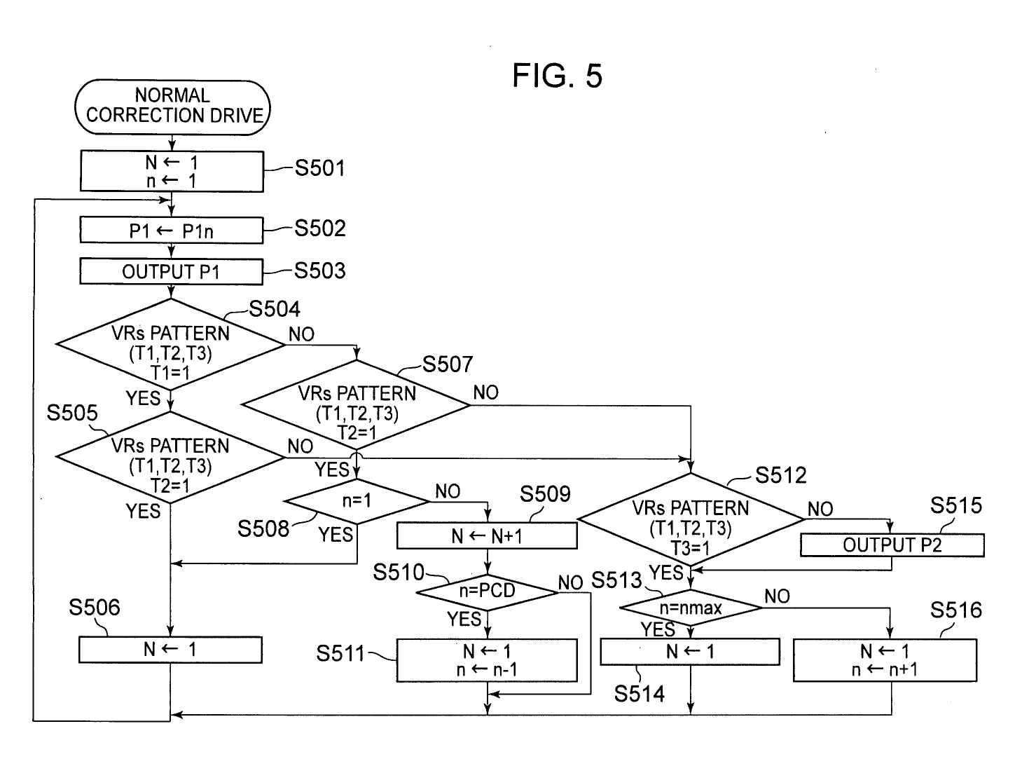

FIG. 5 is a flowchart depicting operations of the stepping motor control circuit and the analog electronic timepiece according to one embodiment of the invention. It is a flowchart depicting a normal correction drive process to rotary drive the stepping motor 102 using a plurality of main drive pulses selected in the drive pulse selection process described above.

Meanings of the respective symbols in FIG. 5 are as follows. That is, P1 indicates a main drive pulse during normal correction drive (a main drive pulse of a second group) and it includes a plurality of types from P11 in the minimum pulse rank to P1max in the maximum pulse rank. A lower-case letter n indicates a pulse rank of the main drive pulses P1 during normal correction drive and it includes a plurality of types from the minimum rank 1 to the maximum rank nmax. A capital N indicates the repetition number of times of the driving by the same main drive pulse P1 and it includes from the minimum value 1 to a predetermined number (PCD). P2 indicates a correction drive pulse during normal correction drive.

Hereinafter, operations of the stepping motor control circuit and the analog electronic timepiece according to one embodiment of the invention will be described in detail with reference to FIG. 1 through FIG. 5.

Initially, when the user performs a reset operation to correct the current time to a correct time by operating an unillustrated operation portion, the oscillation circuit 104 generates the reference clock signal at a predetermined frequency and the frequency dividing circuit 105 frequency-divides the signal generated in the oscillation circuit 104 and outputs a timepiece signal as the timekeeping reference to the control circuit 106.

When the control circuit 106 determines that the reset operation is performed according to the operation described above (Step S401), the control circuit 106 performs a timekeeping operation by counting the time signal and sets the rank m of the main drive pulse P01 first to the minimum rank, “1”, in order to perform the pulse selection process from the main drive pulses P0 in ascending order of the pulse ranks (Step S402). The control circuit 106 reads out information on the main drive pulse P01 having the minimum pulse width from the storage circuit 108 and outputs a control signal so that the stepping motor 102 is rotary driven by the main drive pulse P01 for initial setting having the minimum pulse width (Steps S403 and S404).

The stepping motor drive pulse circuit 107 rotary drives the stepping motor 102 by the main drive pulse P01 in response to the control signal from the control circuit 106. The stepping motor 102 is thus rotary driven by the main drive pulse P01 and rotary drives the unillustrated time hands and the like. Accordingly, when the stepping motor 102 rotates normally, the current time is displayed by the time hands.

The rotation detection circuit 109 outputs a detection signal to the detection time comparison and determination circuit 110 each time it detects an induced signal VRs of the stepping motor 102 exceeding the reference threshold voltage Vcomp. The detection time comparison and determination circuit 110 determines the sections T1 through T3 in which the induced signal VRs exceeding the reference threshold voltage Vcomp is detected according to the detection signal from the rotation detection circuit 109 and notifies the control circuit 106 of the determination values, “1” or “0”, in the respective sections T1 through T3.

The control circuit 106 determines the VRs pattern, (the determination value in the first section T1, the determination value in the second section T2, and the determination value in the third section T3), indicating the rotation condition according to the determination values from the detection time comparison and determination circuit 110.

The control circuit 106 determines whether the determination value in the second section T2 is “1” as the result of the driving by the main drive pulse P01, that is, whether the VRs pattern is (1/0, 1, 1/0) (Step S405). When the control circuit 106 determines that the VRs pattern is (1/0, 1, 1/0), it sets the pulse rank pattern RP01 as the result of the driving by the main drive pulse P01 to “1” (Step S406), after which it drives the stepping motor 102 by the correction drive pulse P2 (Step S407).

In this manner, by selecting the main drive pulse P0 when the VRs pattern is (1/0, 1, 1/0), that is, by selecting the main drive pulse with drive energy as large as or larger than drive energy by which the pulse rank is maintained, by the control circuit 106, it becomes possible to rotary drive the stepping motor 102 precisely during normal correction drive. Also, after the driving by the main drive pulse P0, by driving the stepping motor 102 by the correction drive pulse P2 independently of whether the stepping motor 102 has rotated, it becomes possible to perform the selection process of the main drive pulses P1 while keeping the stepping motor 102 rotated in a reliable manner even when the stepping motor 102 is not rotated by the main drive pulse P0 with insufficient drive energy.

Subsequently, the control circuit 106 determines whether the pulse rank m of the main drive pulses P0 for initial setting reaches the maximum value mmax (Step S408). In a case where the control circuit 106 determines that the pulse rank m has reached the maximum value mmax, it sets the lower limit rank of the main drive pulses P0 for initial setting such that RP0m=1 to mL and the upper limit of the main drive pulses P0 for initial setting such that RP0m=1 to mU in the rank pattern, (RP01, RP02, . . . , and RP0mmax) (Step S409).

Subsequently, the control circuit 106 selects the main drive pulse P0mL in the lower limit rank as the main drive pulse P11 with the minimum main drive energy, the main drive pulse P0(mL+1) one rank upper than P0mL as the main drive pulse P12 one rank upper than the main drive pulse P11, . . . , and the main drive pulse P0mU in the upper limit rank as the main drive pulse P1max with the maximum main drive energy. After the control circuit 106 ends the selection process of the main drive pulses P1 for correction drive, it performs the normal correction drive depicted in FIG. 5 using the selected main drive pulses P11 through P1max and the correction drive pulse P2 (Step S410).

For example, in a case where there are eight types of main drive pulses P0 for initial setting preliminarily provided to the stepping motor control circuit 101, let the pulse rank pattern be (0, 0, 0, 1, 1, 1, 1, 0), then mL=4 and mU=7 are obtained. The main drive pulses P04 through P07 are thus selected. Hence, as the main drive pulses P1 for normal correction drive, four types including P11=P04, P12=P05, P13=P06, and P14=P07 are selected.

In a case where the control circuit 106 determines that the pulse rank m of the main drive pulses P0 for initial setting has not reached the maximum value mmax in Step S408, the control circuit 106 adds 1 to the pulse rank m and returns to Step S403 (Step S413).

In a case where the control circuit 106 determines that the determination value in the second section T2 is not “1”, that is, the VRs pattern is not (1/0, 1, 1/0), in Step S405, the control circuit 106 sets the rank pattern RP0m to “0” and proceeds to Step S407 (Step S412).

In a case where the control circuit 106 determines that the reset operation is not performed in Step S401, when the driving by the correction drive pulse P2 is performed during the normal correction drive, the control circuit 106 proceeds to Step S402 to perform the drive pulse selection process described above, and when the driving by the correction drive pulse P2 is not performed during the normal correction drive, the control circuit 106 proceeds to the normal correction drive process depicted in FIG. 5 (Step S411).

The process described above is performed successively and collectively for all the main drive pulses P01 through P0mmax for initial setting preliminarily provided to the stepping motor control circuit 101. Then, the main drive pulses P11 through P1max for correction drive suitable for the driving of the stepping motor 102 are selected collectively in advance.

In this manner, the control circuit 106 is configured to select the main drive pulses P1 suitable for the driving of the analog electronic timepiece collectively by performing the driving by all the preliminarily provided main drive pulses P0 successively and collectively in one cycle at predetermined timing (herein, when the reset operation or the driving by the correction drive pulse P2 during normal correction drive is performed). It thus becomes possible to drive the stepping motor 102 by selecting the most suitable main drive pulse P1 among the preliminarily selected main drive pulses P1 when the operation of the stepping motor 102 starts or when the load fluctuates. Accordingly, the stepping motor 102 can be driven faster in a reliable manner.

Thereafter, the normal correction drive process depicted in FIG. 5 is performed using the main drive pulses P1 selected as above and stored in the storage circuit 108. The control circuit 106 performs the timekeeping operation by counting the time signal even in the normal correction drive to control the rotary driving of the stepping motor 102.

Referring to FIG. 5, the control circuit 106 initially sets the repetition number of times, N, to 1 and sets the pulse rank n of the main drive pulses P1 to the minimum rank 1 (Step S501). The control circuit 106 therefore outputs a control signal to rotary drive the stepping motor 102 by the main drive pulse P11 having the minimum pulse width (Steps S502 and S503). The stepping motor drive pulse circuit 107 rotary drives the stepping motor 102 by the main drive pulse P11 in response to the control signal.

The rotation detection circuit 109 outputs a detection signal to the detection time comparison and determination circuit 110 each time it detects the induced signal VRs of the stepping motor 102 exceeding the reference threshold voltage Vcomp. The detection time comparison and determination circuit 110 determines the sections T1 through T3 in which the induced signal VRs exceeding the reference threshold voltage Vcomp is detected according to the detection signal from the rotation detection circuit 109 and notifies the control circuit 106 of the determination values, “1” or “0”, in the respective sections T1 through T3.

The control circuit 106 determines the VRs pattern indicating the rotation condition according to the determination values from the detection time comparison and determination circuit 110.

In a case where the determination values in the first section T1 and the second section T2 of the VRs pattern as the result of the driving by the main drive pulse P11 is “1”, that is, in a case where the VRs pattern is (1, 1, 1/0) (Steps 504 and S505), the control circuit 106 determines that the rotation condition is a rotation without an allowance. The control circuit 106 therefore does not change but maintains the rank of the main drive pulse P1 and returns to Step S502 after it sets the number of repetition times, N, to 1 (Step S506).

In a case where the control circuit 106 determines that the induced signal VRs in the second section T2 does not exceed the reference threshold voltage Vcomp (a case where the determination values in the sections T1 and T2 are (1, 0)) in Step S505, when the control circuit 106 determines that the determination value in the third section T3 is “1”, that is, the VRs pattern is (1, 0, 1) (Step S512), the control circuit 106 determines that the rotation condition is a marginal rotation. The control circuit 106 therefore performs the pulse up control to upgrade the drive energy of the main drive pulse P1 by one rank ahead of time without performing the driving by the correction drive pulse P2. Under the pulse up control, the pulse rank of the main drive pulse P1 is not changed when the pulse rank n of the main drive pulse P1 is the maximum value and the control circuit 106 returns to Step S502 after it sets the number of repetition times, N, to 1 (Steps S513 and S514).

When the pulse rank n of the main drive pulse P1 is not the maximum value in Step S513, the control circuit 106 returns to Step 5502 after it upgrades the pulse rank of the main drive pulse P1 by one rank and sets the number of repetition times, N, to 1 (Step S516).

When the control circuit 106 determines that the determination value in the third section T3 is “0”, that is, the VRs pattern is (1, 0, 0), in Step S512, it determines that the rotation condition is a non-rotation. The control circuit 106 therefore drives the stepping motor 102 by the correction drive pulse P2 (Step S515) and returns to Step S502 after it performs the pulse up control (Steps S513, 5514, and S516).

In a case where the determination value in the first section T1 is not “1” in Step S504, when the control circuit 106 determines that the determination value in the second section T2 is “1”, that is, when it determines that the rotation condition is a rotation with an allowance indicated by the VRs pattern of (0, 1, 1/0) (Step S507), the control circuit 106 proceeds to Step S506 when the rank n of the main drive pulse P1 is 1 (Step S508).

In a case where the control circuit 106 determines that the rank n is not 1 in Step S508, it adds 1 to the number of repetition times, N, and when the number of repetition times, N, reaches the predetermined number PCD, the control circuit 106 returns to Step S502 after it sets the number of repetition times, N, to 1 and performs the pulse down by downgrading the rank n by one rank. In a case where the control circuit 106 determines that the number of repetition times, N, has not reached the predetermined number PCD in Step S510, it immediately returns to Step S502 (Steps S509 through S511).

In a case where the control circuit 106 determines that the determination value in the second section T2 is not “1”, that is, in a case where the determination values in the sections T1 and T2 are (0, 0) in Step 5507, it proceeds to Step S512 to perform the process described above.

In this manner, when the VRs patterns are (1/0, 1, 1/0 and (1/0, 0, 1), it is determined that the stepping motor 102 is rotating and the driving by the correction drive pulse P2 is not performed. On the contrary, when the VRs pattern is (1/0, 0, 0), it is determined that the stepping motor 102 is not rotating and the driving by the correction drive pulse P2 is performed.

As has been described, the stepping motor control circuit 101 of this embodiment is configured in such a manner that when the reset operation or the driving by the correction drive pulse P2 is performed, the stepping motor 102 is driven by a plurality of the main drive pulses P0 for initial setting stored in the storage circuit 108 and the stepping motor 102 is rotary driven by the correction drive pulse P2 following the respective main drive pulses P0, so that the main drive pulses P0 with energy as large as or larger than energy by which it is determined to maintain the pulse rank are used as the main drive pulses P1 during normal correction drive.

It thus becomes possible to perform the driving by the main drive pulse P1 suitable for the stepping motor 102 in consideration of a characteristic variation of the stepping motor 102.

In addition, according to the analog electronic timepiece of this embodiment, a precise hand movement operation can be performed because it becomes possible to perform the driving by the main drive pulse P1 suitable for the stepping motor 102 in consideration of a characteristic variation of the stepping motor 102.

Also, there is an advantage that diversified movements from a straight system having a smaller load to a functional system having a calendar load and further to battery placement causing a voltage change can be addressed without having to change the integrated circuit (IC) forming the stepping motor control circuit 101 and the motor specification.

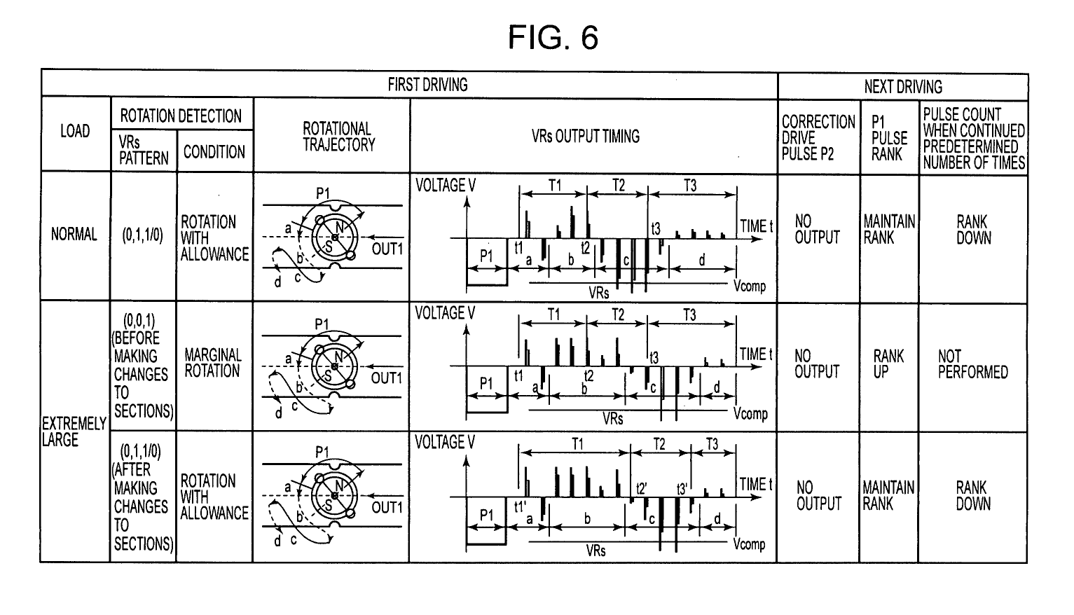

FIG. 6 is a timing chart of the stepping motor control circuit and the analog electronic timepiece according to another embodiment of the invention. Like components are labeled with like reference numerals with respect to FIG. 3.

The VRs pattern, (0, 1, 1/0), is obtained in a normal load state. However, in a case of a fluctuation to an extremely large load, the rotation condition changes to a marginal rotation and the VRs pattern, (0, 0, 1), is obtained. In the drive pulse selection process, in a case where the number of the main drive pulses P1 selected as the main drive pulses P1 in the second group is smaller than the predetermined number, it is configured in such a manner that the VRs pattern, (1/0, 1, 1/0), is obtained instead of the VRs pattern, (0, 0, 1), by changing the breaking of the detection interval T.

In this embodiment, as is shown in FIG. 6, of the three sections T1 through T3 forming the detection interval T, a change is made so that the start position and the end position of the second terminal T2 are delayed. In this case, the length of the second section T2 is not changed to maintain a constant length and the length from the start position of the first section T1 to the end position of the third section T3 is not changed, either, to maintain a constant length. Hence, by delaying the position of the second section T2, the first section T1 becomes longer and the third section T3 becomes shorter. Alternatively, it may be configured in such a manner that the at least one of the lengths, the start positions, and the end positions of the detection interval T, the first section T1, the second section T2, and the third section T3 is changed.

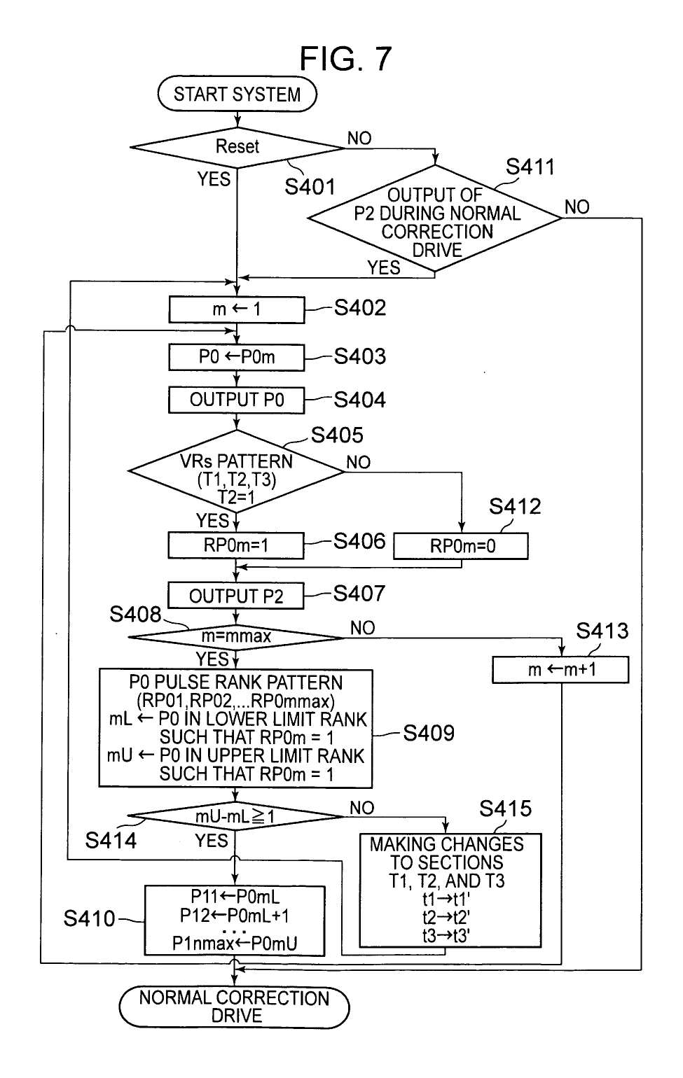

FIG. 7 is a flowchart depicting the drive pulse selection process by the stepping motor control circuit and the analog electronic timepiece according to still another embodiment of the invention. Like components are labeled with like reference numerals with respect to FIG. 4.

The block diagram, the timing during the normal operation, the normal correction drive process, and so forth of this embodiment are the same as those depicted in FIG. 1 through FIG. 3 and FIG. 5.

Hereinafter, operations of this embodiment in part different from the embodiments above will be described chiefly along FIG. 6 and FIG. 7.

The control circuit 106 determines whether the pulse rank m of the main drive pulses P0 for initial setting reaches the maximum value mmax (Step S408). In a case where the control circuit 106 determines that the pulse rank m has reached the maximum value mmax, it sets the lower limit rank of the main drive pulse P0 for initial driving such that RP0m=1 to mL and the upper limit rank of the main drive pulse P0 for initial setting such that RP0m=1 to mU in the rank pattern, (RP01, RP02, . . . , and RP0mmax) (Step S409).

In a case where a difference between the upper limit rank mU and the lower limit rank mL is 1 or more, that is, in a case where the number of the main drive pulses P1 with which the VRs pattern, (1/0, 1, 1/0), is obtained is 2 or more (Step S414), because it is possible to perform the normal correction drive, the control circuit 106 proceeds to Step S410 in which the control circuit 106 selects the main drive pulse P0mL in the lower limit rank mL as the main drive pulse P11 with the minimum drive energy, the main drive pulse P0 (mL+1) one rank upper than the main drive pulse P0mL as the main drive pulse P12 one rank upper than the main drive pulse P11, . . . , and the main drive pulse P0mU in the upper limit rank mU as the main drive pulse P1nmax with the maximum drive energy. After the control circuit 106 ends the selection process of the main drive pulses P1 for correction drive, it performs the normal correction drive depicted in FIG. 5 using the selected main drive pulses P11 through P1nmax and the correction drive pulse P2.

Meanwhile, in a case where the number of the main drive pulses P1 with which the VRs pattern, (1/0, 1, 1/0), is obtained is not 1 or more in Step S414, because it is impossible to perform the normal correction drive in a case where the number of the main drive pulses P1 selected in the drive pulse selection process is 2 or less, the control circuit 106 makes a change to the detection interval T so that the VRs pattern, (1/0, 1, 1/0), can be obtained (see FIG. 6), after which the control circuit 106 returns to Step S402 (Step S415) to perform the pulse selection process again from the start.

In this manner, according to this embodiment, in a case where at least a predetermined number of the main drive pulses P1 are not selected in the pulse selection process, the breaking of the detection interval T is changed and then the pulse selection process is performed again. Accordingly, diversified movement specifications from a load having a small moment, such as a small hand, to a load having a large moment, such as a disc hand, can be addressed. Also, the movement specifications can be addressed using a fewer types of the main drive pulses P1.

In the respective embodiments above, it is configured in such a manner that information on the main drive pulses P0 for initial setting and the main drive pulses P1 for normal correction drive is stored in the storage circuit 108 and read out to perform the driving. It should be appreciated, however, that hardware is also available.

Also, in the respective embodiments above, in order to change the energy of the respective main drive pulses P1, a pulse width of a rectangular wave is made different. It should be appreciated, however, that drive energy can be changed also by forming the pulse itself in a comb-shaped wave, by changing ON/OFF duty, or by changing a pulse voltage.

Also, the above described a case of the calendar function as an example of the load that fluctuates considerably. It should be appreciated, however, that the invention is also applicable to various loads, such as a load that makes a character provided to the display portion move in certain motions to inform a predetermined time.

Further, the above described a case of the electronic timepiece as an example of application of the stepping motor. It should be appreciated, however, that the invention is also applicable to an electronic device using a motor.

The stepping motor control circuit of the invention is applicable to various electronic devices using a stepping motor.

The electronic timepiece of the invention is applicable to various types of analog electronic timepieces including various analog electronic timepieces with a calendar function, such as an analog electronic watch with a calendar function and an analog electronic clock with a calendar function.

What is claimed is:

1. A stepping motor control circuit, comprising:
a rotation detection portion that detects an induced signal generated by a rotation of a rotor in a stepping motor and detects a rotation condition of the stepping motor depending on whether the induced signal exceeds a predetermined reference threshold voltage within a predetermined detection interval; and
a control portion that drives and controls the stepping motor by one of any one of a plurality of main drive pulses in pulse ranks that differ from one another and a correction drive pulse with energy larger than energy of the respective main drive pulses according to a detection result of the rotation detection portion,
wherein the control portion preliminarily selects main drive pulses of a second group made up of a plurality of main drive pulses capable of rotary driving the stepping motor collectively from main drive pulses of a first group made up of a plurality of preliminarily provided main drive pulses and drives and controls the stepping motor by one of any one of the main drive pulses of the second group and the correction drive pulse according to the detection result of the rotation detection portion.

2. The stepping motor control circuit according to claim 1, wherein:
the control portion selects the main drive pulses of the second group collectively from the main drive pulses of the first group at predetermined timing while performing a driving operation of the stepping motor.

3. The stepping motor control circuit according to claim 2, wherein:
the control portion selects the main drive pulses of the second group collectively from the main drive pulses of the first group when one of a reset operation and driving by the correction drive pulse is performed.

4. The stepping motor control circuit according to claim 3, wherein:
the control portion selects the main drive pulses of the second group by performing driving by a set of a main drive pulse of the first group and the correction drive pulse following this main drive pulse for the respective main drive pulses of the first group after one of the reset operation and the driving by the correction drive pulse is performed.

5. The stepping motor control circuit according to claim 1, wherein:
the detection interval is divided to a plurality of sections immediately after driving by a main drive pulse and the control portion selects the main drive pulses of the second group from the main drive pulses of the first group according to a pattern of the induced signal in the plurality of sections.

6. The stepping motor control circuit according to claim 2, wherein:
the detection interval is divided to a plurality of sections immediately after driving by a main drive pulse and the control portion selects the main drive pulses of the second group from the main drive pulses of the first group according to a pattern of the induced signal in the plurality of sections.

7. The stepping motor control circuit according to claim 3, wherein:
the detection interval is divided to a plurality of sections immediately after driving by a main drive pulse and the control portion selects the main drive pulses of the second group from the main drive pulses of the first group according to a pattern of the induced signal in the plurality of sections.

8. The stepping motor control circuit according to claim 4, wherein:
the detection interval is divided to a plurality of sections immediately after driving by a main drive pulse and the control portion selects the main drive pulses of the second group from the main drive pulses of the first group according to a pattern of the induced signal in the plurality of sections.

9. The stepping motor control circuit according to claim 5, wherein:
the control portion selects a main drive pulse with energy as large as or larger than energy by which it is determined to maintain a pulse rank according to the pattern of the induced signal in the plurality of sections as the main drive pulses of the second group.

10. The stepping motor control circuit according to claim 6, wherein:
the control portion selects a main drive pulse with energy as large as or larger than energy by which it is determined to maintain a pulse rank according to the pattern of the induced signal in the plurality of sections as the main drive pulses of the second group.

11. The stepping motor control circuit according to claim 7, wherein:
the control portion selects a main drive pulse with energy as large as or larger than energy by which it is determined to maintain a pulse rank according to the pattern of the induced signal in the plurality of sections as the main drive pulses of the second group.

12. The stepping motor control circuit according to claim 8, wherein:
the control portion selects a main drive pulse with energy as large as or larger than energy by which it is determined to maintain a pulse rank according to the pattern of the induced signal in the plurality of sections as the main drive pulses of the second group.

13. The stepping motor control circuit according to claim 5, wherein:
the detection interval is divided to a first section immediately after driving by a main drive pulse, a second section later than the first section, and a third section later than the second section, and the first section is a section in which to determine a rotation of the rotor in a positive direction in a second quadrant about the rotor and the second section and the third section are sections in which to determine a rotation of the rotor in an inverse direction in a third quadrant; and
the control portion selects the main drive pulses of the second group from the main drive pulses of the first group according to the pattern in the first through third sections.

14. The stepping motor control circuit according to claim 6, wherein:
the detection interval is divided to a first section immediately after driving by a main drive pulse, a second section later than the first section, and a third section later than the second section, and the first section is a section in which to determine a rotation of the rotor in a positive direction in a second quadrant about the rotor and the second section and the third section are sections in which to determine a rotation of the rotor in an inverse direction in a third quadrant; and
the control portion selects the main drive pulses of the second group from the main drive pulses of the first group according to the pattern in the first through third sections.

15. The stepping motor control circuit according to claim 7, wherein:
the detection interval is divided to a first section immediately after driving by a main drive pulse, a second section later than the first section, and a third section later than the second section, and the first section is a section in which to determine a rotation of the rotor in a positive direction in a second quadrant about the rotor and the second section and the third section are sections in which to determine a rotation of the rotor in an inverse direction in a third quadrant; and
the control portion selects the main drive pulses of the second group from the main drive pulses of the first group according to the pattern in the first through third sections.

16. The stepping motor control circuit according to claim 13, wherein:
the control portion selects a main drive pulse with which the induced signal exceeding the reference threshold voltage is detected in the second section of the pattern as the main drive pulses of the second group.

17. The stepping motor control circuit according to claim 1, further comprising:
a storage portion that stores information on the main drive pulses of the first group and the main drive pulses of the second group,
wherein the control portion selects the main drive pulses of the second group using the information on the main drive pulses of the first group stored in the storage portion, stores the information on the main drive pulses of the second group in the storage portion, and performs driving using the main drive pulses of the second group stored in the storage portion after the main drive pulses of the second group are selected.

18. The stepping motor control circuit according to claim 1, wherein:
when the number of main drive pulses selected as the main drive pulses of the second group is smaller than a predetermined number, the control portion selects the main drive pulses of the second group from the main drive pulses of the first group while performing a driving operation of the stepping motor after a change is made to the detection interval.

19. The stepping motor control circuit according to claim 18, wherein:
when the number of main drive pulses selected as the main drive pulses of the second group is smaller than the predetermined number, the control portion selects the main drive pulses of the second group from the main drive pulses of the first group while performing the driving operation of the stepping motor after at least one of a length, a start position, and an end position of one of the detection interval and the respective sections forming the detection interval is changed.

20. An analog electronic timepiece, comprising:
a stepping motor that rotary drives time hands; and
a stepping motor control circuit that controls the stepping motor,
wherein the stepping motor control circuit set forth in claim 1 is used as the stepping motor control circuit.
